(19) United States
(12) Patent Application Publication
(10) Pub. No.: US 2005/0025159 A1
(43) Pub. Date: Feb. 3, 2005

(54) Method for transmitting data in radio access networks

(76) Inventors: Duan-Shin Lee, Taipei City (TW); Chiung-Sui Liu, Yongkang City (TW); Sheng-Hsien Chen, Taipei City (TW); Ching-Yu Lin, Hsinchu City (TW)

Correspondence Address: SNELL & WILMER;ONE ARIZONA CENTER, 400 EAST VAN BUREN, PHOENIX, AZ, 850040001, US

(21) Appl. No.: 10/891,656

(22) Filed: Jul. 15, 2004

(30) Foreign Application Priority Data
Jul. 15, 2003 (TW) 92119292

(51) Int. Cl. H04L 12/28

(52) U.S. Cl. 370/395.42

(57) ABSTRACT

Four methods for transmitting data in base stations of radio access network are provided. Each base station includes a plurality of logic channels, a plurality of transport channels and a media access control layer. The logic channels are configured to receive data and transmit it to the media access control layer. The media access control layer distributes the data by means of the methods of the preset invention and then the data is able to transmit through the transport channels.

### CROSS-REFERENCE TO RELATED APPLICATION

This Application claims priority to Taiwan Patent Application No. 092119292 filed on Jul. 15, 2003.

### FIELD OF INVENTION

The present invention is related to a method for transmitting data in base stations of radio access networks.

### BACKGROUND OF THE INVENTION

The second generation wireless communications system is designed to transmit audio and text data. With the progress of technology and the requirement of market, it is now configured to transmit the data with other formats, such as an image. To obtain a better performance, a third generation wireless communications system is introduced to the market. The third generation wireless communications system such as Universal Mobile Telecommunications System (UMTS) can support packet data services which receive multiple data of different formats and respectively transmit them to different applications after being decoded.

Data transmission in base stations of a radio access network is one application of UMTS. It includes a plurality of logic channels to deliver different transmission services, e.g. audio, text and image, to a media access control (MAC) layer of radio access network. Normally, the media access control layer is implemented in communication software based on ISO communication OSI 7 layers. Each logic channel has a buffer for temporarily storing unsent data. These transmission services, after being arranged by the MAC layer, are outputted to the physical layer of radio access network through a plurality of transport channels.

The MAC layer has a table in which a transport format combination set (TFCS) is stored. The TFCS includes the transport format combinations (TFC) the MAC layer may accept. The MAC layer selects one TFC from the TFCS to transmit data. For example, TFCS={(1, 2), (2, 4), (3, 1)}, which represents that the exemplary system has two transport channels and acceptable TFCs are (1, 2), (2, 4) and (3, 1). If (2, 4) is selected in a certain time frame, there are two transport blocks for the first transport channel and four transport blocks for the second transport channel. Assuming that each block is 8 bits, the first transport channel can transmit 16(=8×2) bits and the second transport channel can transmit 32(=8×4) bits in this time frame. Selecting an acceptable TFC appropriately can shorten waiting time of transmission and further improve system performance.

Therefore, it is a desirable to select an acceptable TFC appropriately and efficiently in the field of UMTS.

### SUMMARY OF THE INVENTION

The present invention provides four methods to transmit data in base stations of radio access networks, which are Strict Priority Method, Dynamic Priority Method, Probability Priority Method and Load Measurement Based Priority Method.

Strict Priority Method considers the priority attribute of each set of data. The steps are: (a) dividing M sets data into N groups, each group of data corresponding to one transport channel; (b) for each group, determining which set of data has a highest priority attribute and defining the set of data having the highest priority attribute as a main set of data of a corresponding group; (c) from one group having a corresponding main set of data with a highest priority attribute to one group having a corresponding main set of data with a lowest priority attribute, excluding TFCs that are incapable of carrying the corresponding main set of data; and (d) selecting one of available TFCs from the TFCS to process data transmission.

Unlike Strict Priority Method, Dynamic Priority Method considers the priority attribute of each set of data and the quantity of the data in buffers simultaneously to determine the number of bits for transmission in each group. The steps are: (a) setting a buffer threshold; (b) dividing M sets data into N groups, each group of data corresponding to one transport channel; (c) determining if a quantity of the set of data in each buffer is larger than the buffer threshold, if yes, marking the set of data as H, if not, marking the set of data as L; (d) for each group, appropriately replacing priority attributes according to the H and L marks of the data in each group; and (e) transmitting the M sets data based on the priority attributes after replacement.

Probability Priority Method computes a transport probability and a transport value of each group to determine transmission priorities. The steps are: (a) computing a transport probability of each group; (b) computing a transport value of each group, wherein a probability of the transport value as being 1 is the transport probability of the each group, which means the data in the group can be considered in the time frame, and a probability of the transport value as being 0 is (1 minus the transport probability of the each group), which means the data in the group would not be considered in the time frame; (c) from one group having a largest transport probability to one group having a smallest transport probability, excluding TFCs that are incapable of carrying all data in the group if the transport value of the group is equal to 1; and (d) selecting one of available TFCs from the TFCS to process data transmission.

To take the data float of each logic channel into account, Load Measurement Based Priority Method assigns transport blocks to each transport channel in the current time frame by pre-estimating or pre-computing a possible input quantity of data in the next time frame in addition to priority attributes. The steps are: (a) dividing M sets data into N groups, each group of data corresponding to one transport channel; (b) for each group, computing a group-weight by using the priority attributes of all data and the quantity of data, and forming N group-weights; (c) from one group having a largest group-weight to one group having a smallest group-weight or only one TFC available in the TFCS, excluding TFCs that are incapable of carrying all quantities of data in corresponding group; and (d) allotting the transport blocks to the N groups; and transmitting the M sets data.

### BRIEF DESCRIPTION OF THE DRAWINGS

FIG. 1 illustrates a partial structure of radio access network;

FIG. 2 illustrates the flow chart of Strict Priority Method of the present invention;

FIG. 3 illustrates the flow chart of Dynamic Priority Method of the present invention;

FIG. 4 illustrates a first flow chart of Dynamic Priority Method of the present invention when priority attributes are replaced;

FIGS. 5A-C illustrate a first embodiment of Dynamic Priority Method;

FIG. 6 illustrates a second flow chart of Dynamic Priority Method of the present invention when priority attributes are replaced;

FIGS. 7A-C illustrate a second embodiment of Dynamic Priority Method;

FIG. 8 illustrates the flow chart of Probability Priority Method of the present invention;

FIG. 9 illustrates an embodiment of Probability Priority Method;

FIG. 10 illustrates the flow chart of Load Measurement Based Priority Method of the present invention; and

FIG. 11 illustrates the flow chart of Load Measurement Based Priority Method of the present invention when transport blocks are allotted.

### DETAILED DESCRIPTION

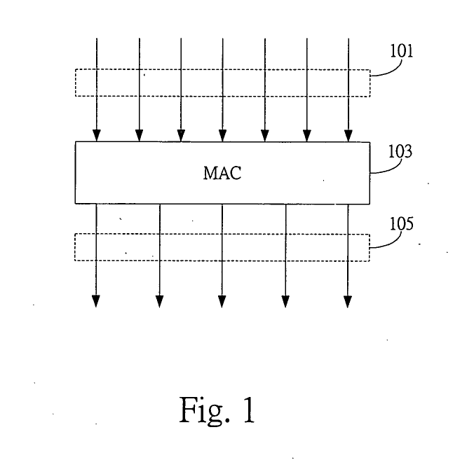

The structure of the radio access network, shown in FIG. 1, includes a plurality of logic channels 101, a MAC layer 103 and a plurality of transport channels 105. The plurality of logic channels 101 are configured to respectively receive data of different transmission services, e.g. audio, text and image, and transmit them to the MAC layer 103. After processing, the MAC layer 103 delivers the data out through the plurality of transport channels 105.

More specifically, the methods of the present invention receive M sets data from M logical channels and store the data in the MAC layer 103 temporarily. The MAC layer 103 processes and then outputs the M sets data via N transport channels. M is larger than N herein, which means that the number of the logic channels is larger than that of the transport channels. Each set of data has a priority attribute to represent its transmission priority.

The MAC layer 103 includes a set of transport format combinations, i.e. TFCS, which includes TFCs accessible to the N transport channels 105. In other words, the M sets data cannot be transmitted in any arbitrary combinations. They must be rearranged to conform to the capacity of the built-in TFCs.

Strict Priority Method

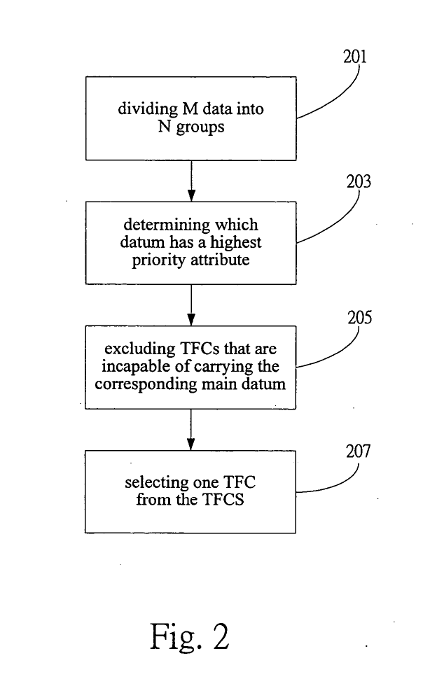

The method considers the priority attribute of each set of data during transmission. The steps are shown in FIG. 2. In step 201, the M sets data are divided into N groups. Each group of data corresponds to one transport channel. In step 203, in each group, it is determined which set of data has a highest priority attribute and the set of data having the highest priority attribute is defined as a main set of data of the corresponding group. In step 205, the TFCs that are incapable of carrying the corresponding main set of data with a highest priority attribute compared to other main data are excluded. Then the TFCs that are incapable of carrying the corresponding main set of data with a second highest priority attribute compared to other main data are excluded. The exclusion step goes on until the main set of data with a lowest priority attribute is considered. In step 207, one of available TFCs is selected from the TFCS to process data transmission.

If there is more than one set of data having the highest priority attribute in the group, the method at random defines one set of data having the highest priority attribute in the group as the main set of data or defines one set of data having the highest priority attribute as well as having the largest quantity of data in the group as the main set of data.

In step 205, if only one TFC available in the TFCS before the group, having the corresponding main set of data with the lowest priority attribute, is considered, the step 205 is terminated and the method goes to step 207 to transmit data with the available TFC. If there are some data that cannot be sent in the current time frame when a TFC is selected, the unsent data will be detained and wait for transmission in next time frame. More specifically, the method terminates step 205 and goes to step 207 under two conditions: one is that the main set of data with the lowest priority attribute is considered and the other is that only one TFC is available in the TFCS.

Assume that an exemplary embodiment of the method has three transport channels A, B and C, and a TFCS={(5, 7, 8), (3, 2, 9), (2, 6, 1), (4, 7, 4), (2, 2, 8)}. In step 201, M sets data is divided into A, B and C groups respectively corresponding to A, B and C logical channels. In step 203, assume that the main set of data of A group is determined as being D1 with P₁=2 and TB₁=3, the main set of data of B group is determined as being D2 with P₂=1 and TB₂=5, and the main set of data of C group is determined as being D3 with P₃=4 and TB₃=6, wherein Pi denotes the priority attribute of Di and TBᵢ denotes the number of the required transport blocks of Di. In step 205, since P₂>P₁>P₃ (the symbol “>” herein represents “higher than”), D2 is first considered. The available TFCs for D2 are (5, 7, 8), (2, 6, 1) and (4, 7, 4). Then D1 is considered and the available TFCs for D1, as well as for D2, are (5, 7, 8) and (4, 7, 4). Finally, D3 is considered and the available TFC for D3, as well as for D2 and D1, is (5, 7, 8). In step 207, the TFC (5, 7, 8) is used to proceed with data transmission.

Dynamic Priority Method

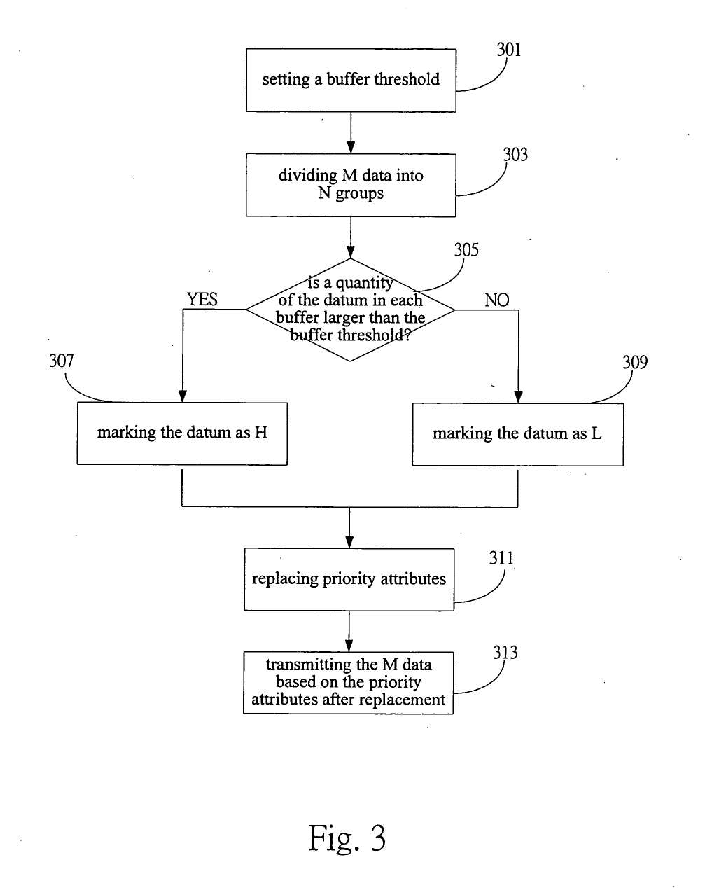

In addition to considering priority attributes, Dynamic Priority Method also takes quantities of data in buffers into account to select an available TFC as FIG. 3 shows. In step 301, a buffer threshold is set. The buffer threshold, between 0 and 1, is used to represent the ratio of a pre-determined threshold quantity of data in a buffer and the capacity of the buffer. In step 303, the M sets data is divided into N groups. Each group of data corresponds to one transport channel. In step 305, the method determines if a quantity of data stored in each buffer is larger than the buffer threshold. If yes, the method goes to step 307 and the set of data is marked as H. Otherwise, the method goes to step 309 and the set of data is marked as L. In step 311, priority attributes are replaced appropriately according to the H and L marks of the data in each group. In step 313, the method transmits the M sets data based on the priority attributes after replacement.

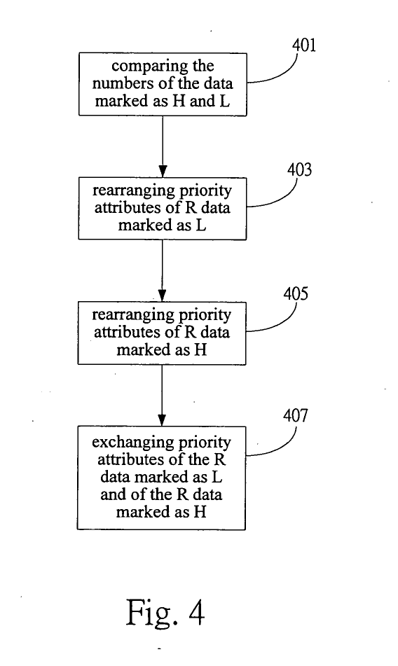

Step 311 may further include the steps as FIG. 4 shows. In step 401, the method compares the numbers of the data marked as H and L in each group and assume that the smaller number of the two is R. In step 403, priority attributes of R data marked as L of each group are rearranged so that each of the R data marked as L with a larger quantity has a higher priority attribute. It is noted that the R data marked as L are R data marked as L with smaller quantities in each group. In step 405, priority attributes of R data marked as H of each group are rearranged so that each of the R data marked as H with a larger quantity has a higher priority attribute. It is noted that the R data marked as H are R data marked as H with larger quantities in each group. In step 407, priority attributes of a set of data marked as L, with a highest priority attribute in the R data marked as L, and a set of data marked as H, with a highest priority attribute in the R data marked as H, are exchanged, and priority attributes of a set of data marked as L, with a second highest priority attribute in the R data marked as L, and a set of data marked as H, with a second highest priority attribute in the R data marked as H, are exchanged, and so on.

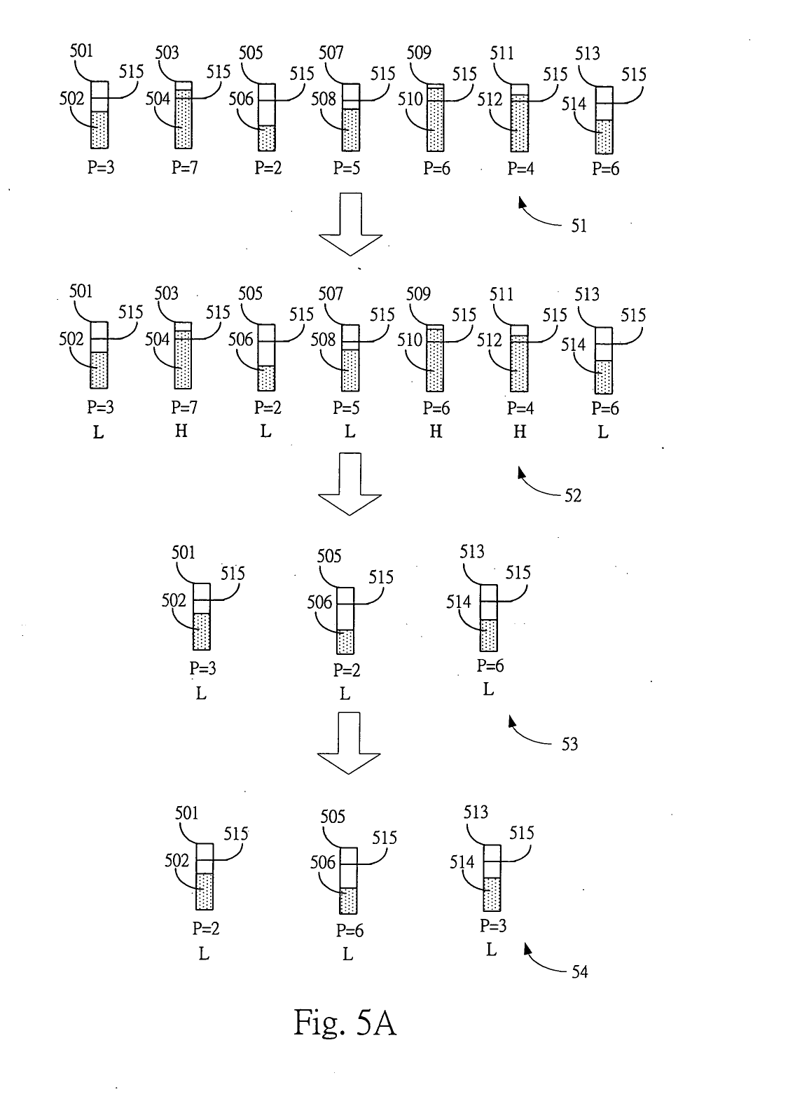

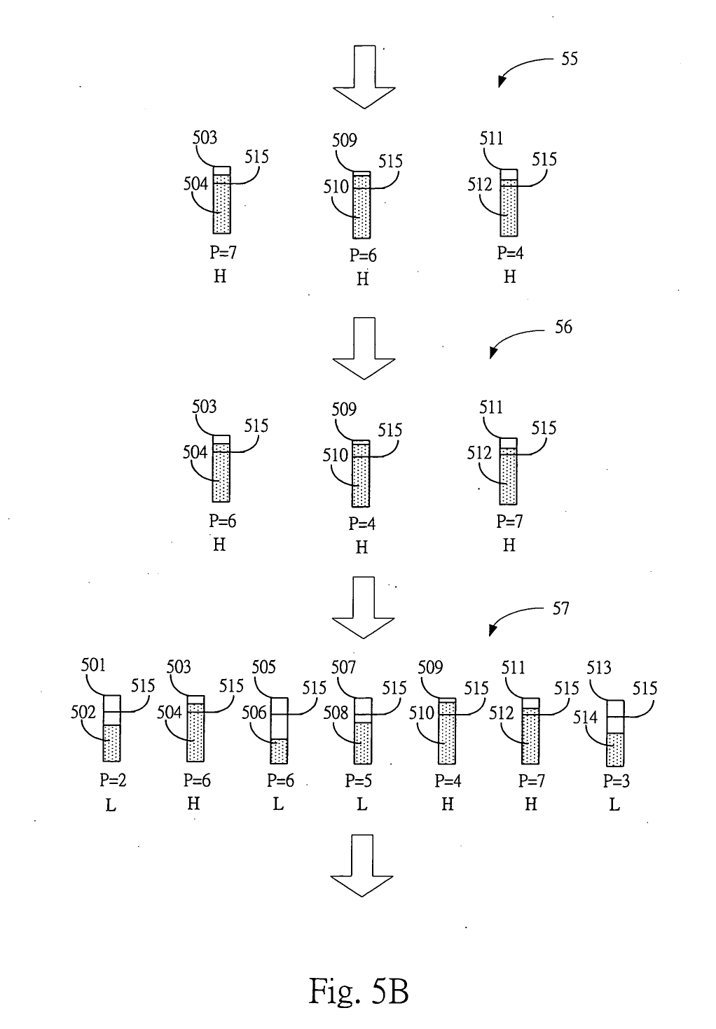

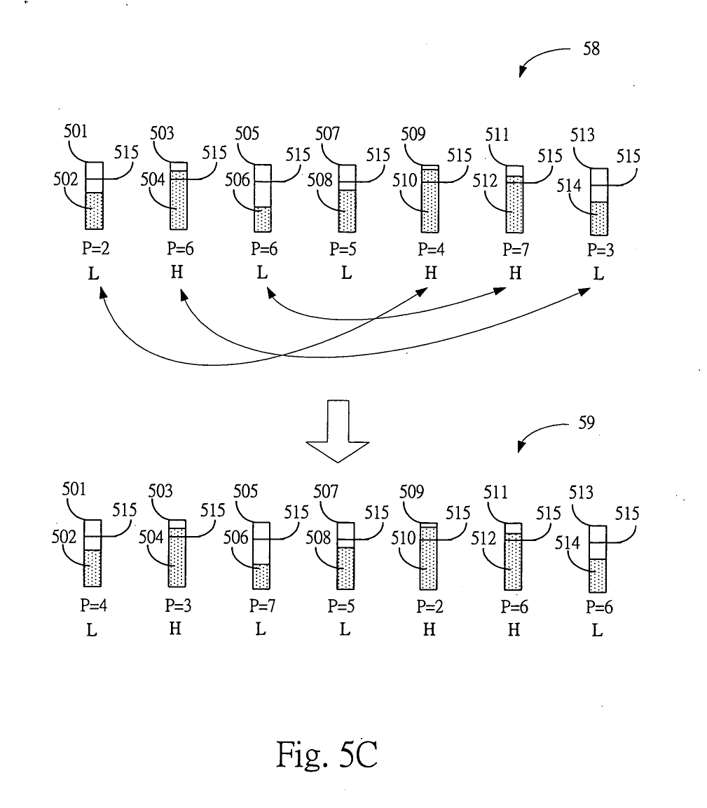

FIGS. 5A-C show an embodiment of data transmission using the method. In step 301, a buffer threshold 515 is set as 0.7 (70% of the capacity of a buffer). In step 303, quantities of data 502, 504, . . . , 514 are received respectively from seven logic channels and are respectively stored in the buffers 501, 503, . . . , 513 in the current time frame. All of them are divided into one group as shown at stage 51 of FIG. 5A. Each set of data has a priority attribute shown below the corresponding buffer, such as the priority attribute of the set of data 502 is 3 and the priority attribute of the set of data 504 is 7. The priority attributes of this embodiment are defined from 1 (highest) to 8 (lowest).

In steps 305, 307 and 309, the buffers 503, 509 and 511 are marked as H because their quantities of data are larger than the buffer threshold 515 and the buffers 501, 505, 507 and 513 are marked as L because their quantities of data are smaller than the buffer threshold 515 as stage 52 shows.

In step 401, as stage 52 also shows, there are three buffers marked as H and four buffers marked as L. Therefore, the smaller number R is equal to 3.

In step 403, the three buffers 501, 505 and 513 marked as L with smaller quantities of data are selected as stage 53 shows. The priority attribute of the set of data 508 stored in the buffer 507 does not need to be rearranged. Next, the priority attributes of the data 502, 506 and 514 stored in the buffers 501, 505 and 513 are rearranged so that the set of data with a larger quantity has a higher priority attribute. Hence, the priority attributes of the data 502, 506, 514 are respectively rearranged as 2, 6 and 3 as stage 54 shows.

In step 405, the three buffers 503, 509 and 511 marked as H with larger quantities of data are selected as stage 55 shows. That would be all buffers marked as H in this embodiment. Next, the priority attributes of the data 504, 510 and 512 stored in the buffers 503, 509 and 511 are rearranged so that the set of data with a larger quantity has a higher priority attribute. Hence, the priority attributes of the data 504, 510 and 512 are respectively rearranged as 6, 4 and 7 as stage 56 shows.

After rearrangement, the priority attributes of data 502, 504, . . . , 514 are shown at stage 57.

In step 407, the priority attributes of data 502 and 510 are exchanged, the priority attributes of data 504 and 514 are exchanged, and the priority attributes of data 506 and 512 are exchanged as stage 58 shows. The new priority attributes of all data 502, 504, . . . 514 are shown at stage 59.

With reference to stage 59, one can observe that, roughly speaking, the buffers, with larger quantities, have higher priority attributes and hence are transmitted first. This can avoid a buffer being too full to store a following set of data in the next time frame.

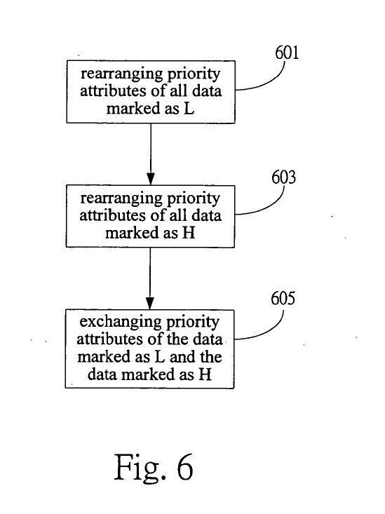

In addition to the steps of FIG. 4, step 311 may be executed by following the steps in FIG. 6. In step 601, the priority attributes of all data marked as L in each group are rearranged so that a set of data marked as L with a larger quantity has a higher priority attribute. In step 603, the priority attributes of all data marked as H in each group are rearranged so that a set of data marked as H with a larger quantity has a higher priority attribute. In step 605, for each group the priority attributes of a set of data marked as L, with a highest priority attribute, and a set of data marked as H, with a highest priority attribute, are exchanged, the priority attributes of a set of data marked as L, with a second highest priority attribute, and a set of data marked as H, with a second highest priority attribute, are exchanged, and so on.

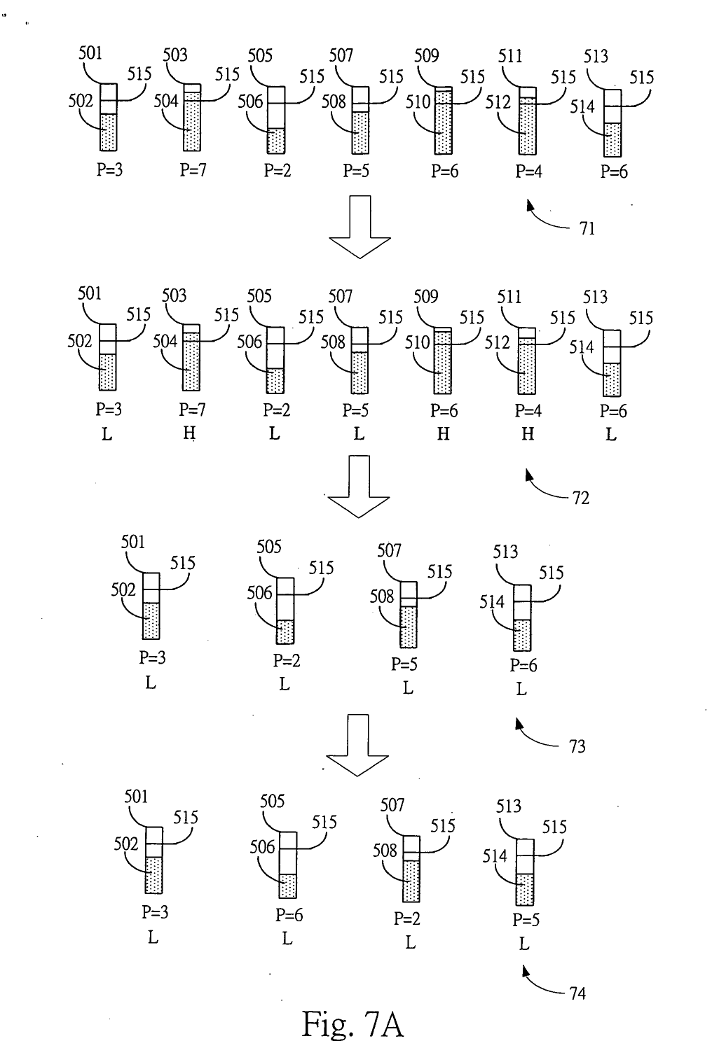

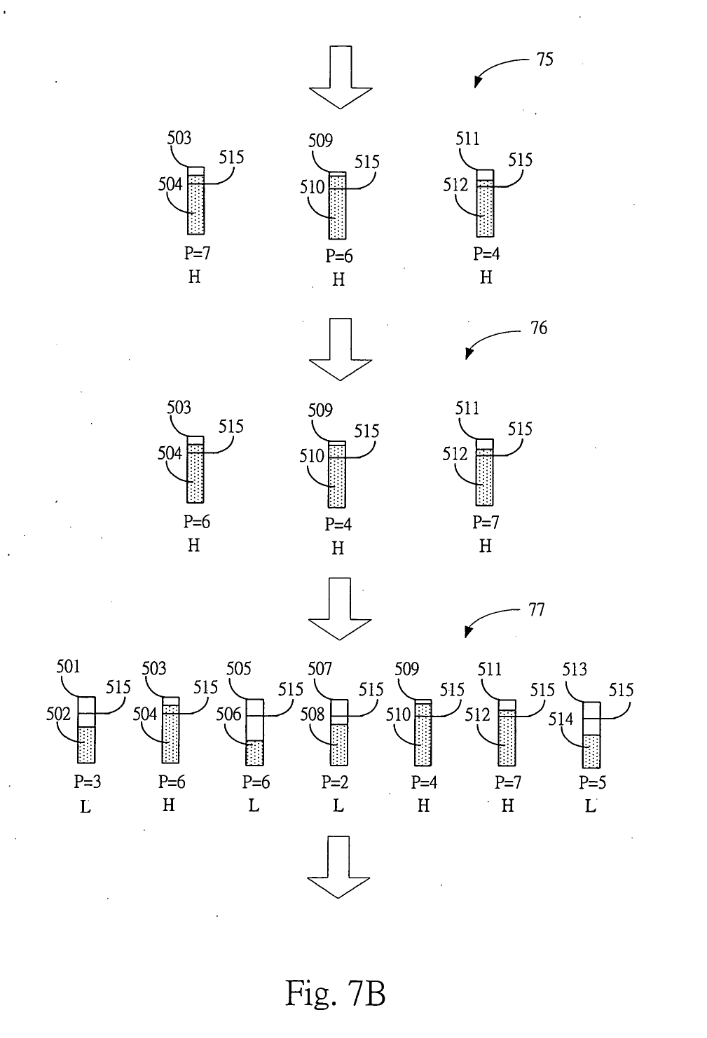

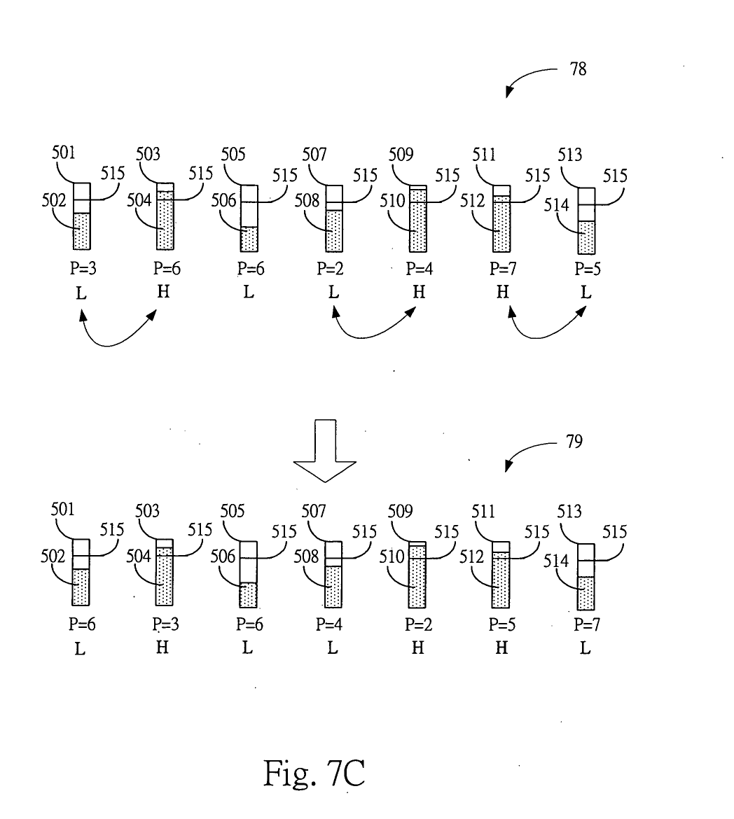

FIGS. 7A-C show an embodiment of data transmission using the method with the steps of FIG. 6. In step 301, a buffer threshold 515 is set as 0.7 (70% of the capacity of a buffer). In step 303, data 502, 504, . . . , 514 are respectively received from seven logic channels and are respectively stored in buffers 501, 503, . . . , 513. All of them are divided into one group as shown at stage 71 of FIG. 7A. The initial conditions of stage 71 are the same as stage 51.

In steps 305, 307 and 309, the buffers 503, 509 and 511 are marked as H because their quantities of data are larger than the buffer threshold 515 and the buffers 501, 505, 507 and 513 are marked as L because their quantities of data are smaller than the buffer threshold 515 as stage 72 shows.

In step 601, the four buffers 501, 505, 507 and 513 marked as L are selected as stage 73 shows. Then the priority attributes of the data 502, 506, 508 and 514 stored in the buffers 501, 505, 507 and 513 are rearranged so that the set of data with a larger quantity has a higher priority attribute. Hence, the priority attributes of the data 502, 506, 508 and 514 are respectively rearranged as 3, 6, 2 and 5 as stage 74 shows.

In step 603, the three buffers 503, 509 and 511 marked as H are selected as stage 75 shows. Next, the priority attributes of the data 504, 510 and 512 stored in the buffers 503, 509 and 511 are rearranged so that the set of data with a larger quantity has a higher priority attribute. Hence, the priority attributes of the data 504, 510 and 512 are respectively rearranged as 6, 4 and 7 as stage 76 shows. After rearrangement, the priority attributes of data 502, 504, . . . , 514 are shown at stage 77.

In step 605, the priority attributes of data 502 and 504 are exchanged, the priority attributes of data 508 and 510 are exchanged, and the priority attributes of data 512 and 514 are exchanged as stage 78 shows. The new priority attributes of all data 502, 504, . . . , 514 are shown at stage 79.

With reference to stage 79, one can observe that, roughly speaking, the buffers, with larger quantities, have higher new priority attributes and hence are transmitted first. This can avoid a buffer being too full to store a set of data in the next time frame.

No matter the steps of FIG. 4 or the steps of FIG. 6 are used, step 313 can be performed by using Strict Priority Method of the present invention.

Probability Priority Method

The third method of the present invention computes transport probabilities of all groups to obtain transport values. According to the transport values, the method determines transmission priorities. One characteristic of the method is that the set of data with a lower priority attribute also has a likeliness to be transmitted first.

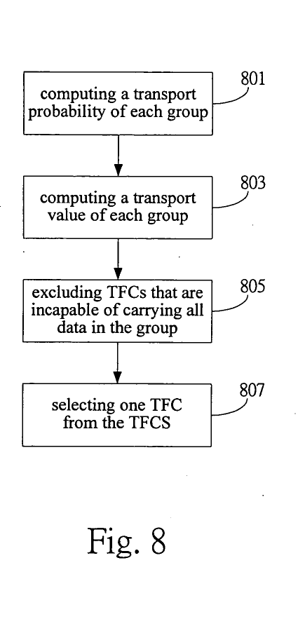

The steps of the method are shown in FIG. 8. In step 801, a transport probability of each group is computed by the following equation:

$${Prob}_{i} = \frac{{{\sum }^{}}_{j ∈ Si} \frac{1}{{P}_{j}}}{{{\sum }^{}}_{j ∈ S} \frac{1}{{P}_{j}}} \qquad ( 1 )$$

wherein Probᵢ denotes the transport probability of the i^{th} group, Pⱼ denotes the priority attribute of the j^{th} set of data, Sᵢ denotes the i^{th} group, and S denotes all of the groups. The transport probability derived by Equation 1 represents the weight of the total priority attributes of the data in the corresponding group compared to the total priority attributes of the data in all groups.

In step 803, a transport value of each group is computed. The probability of the transport value as being 1 is the transport probability of the each group. The probability of the transport value as being 0 is (1 minus the transport probability of the each group). Hence the transport value of each group is either 1 or 0.

In step 805, from one group having a largest transport probability to one group having a smallest transport probability, TFCs that are incapable of carrying all data in the group if the transport value of the group is equal to 1 are excluded. If the transport value of the group is equal to 0, the group will be ignored in the current time frame.

In step 807, one available TFC is selected from the TFCS to process data transmission. If there is more than one group having the same transport probability, randomly select one of the groups having the same transport probability to exclude TFCs, or first exclude the TFCs that are incapable of carrying all data in the group having the largest quantity among the groups having the same transport probability. However, if only one TFC is available in the TFCS before the group, having the smallest transport probability, is considered, the available TFC is selected directly. Some data that are unable to be transmitted in the current time frame, will be considered again in the next time frame. If there is more than one TFC available in the TFCS after step 805 is finished, an available TFC that is capable of carrying the most quantity of data is selected in step 807.

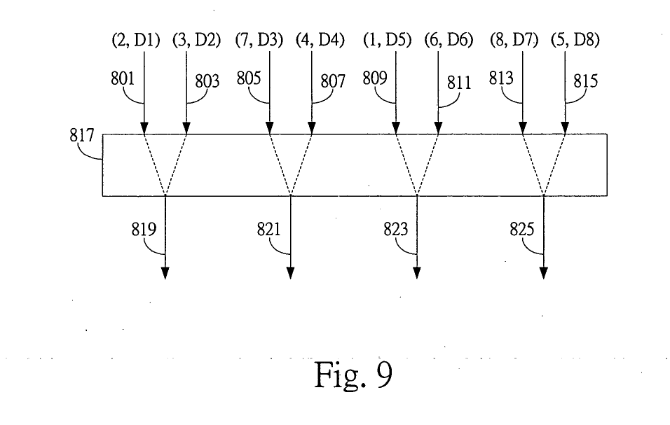

An embodiment of the method is illustrated in FIG. 9. The embodiment has eight logic channels 801, 803, . . . , 815 and four transport channels 819, 821, 823 and 825. Eight data D1, D2, . . . , D8 from the eight logical channels 801, 803, . . . , 815 are divided into four groups, e.g. the 1^{st} group includes the data D1 and D2 from the logic channels 801, 803, and the 2^{nd} group includes the data D3 and D4 from logic channels 805, 807. Each of the logical channels 801, 803, . . . , 815 carries two pieces of information: a priority attribute and a set of data. For example, the priority attribute and the set of data carried by the 1^{st} logical channel are respectively 2 and D1.

In step 801, the transport probabilities of all groups derived from Equation 1 are:

$$\begin{matrix}{Prob}_{1} = \frac{\frac{1}{2} + \frac{1}{3}}{\frac{1}{2} + \frac{1}{3} + \frac{1}{7} + \frac{1}{4} + \frac{1}{1} + \frac{1}{6} + \frac{1}{8} + \frac{1}{5}} = 0.307 \\ {Prob}_{2} = \frac{\frac{1}{7} + \frac{1}{4}}{\frac{1}{2} + \frac{1}{3} + \frac{1}{7} + \frac{1}{4} + \frac{1}{1} + \frac{1}{6} + \frac{1}{8} + \frac{1}{5}} = 0.144 \\ {Prob}_{3} = \frac{\frac{1}{1} + \frac{1}{6}}{\frac{1}{2} + \frac{1}{3} + \frac{1}{7} + \frac{1}{4} + \frac{1}{1} + \frac{1}{6} + \frac{1}{8} + \frac{1}{5}} = 0.429 \\ {Prob}_{4} = \frac{\frac{1}{8} + \frac{1}{5}}{\frac{1}{2} + \frac{1}{3} + \frac{1}{7} + \frac{1}{4} + \frac{1}{1} + \frac{1}{6} + \frac{1}{8} + \frac{1}{5}} = 0.120\end{matrix}$$

In step 803, one can use a random number table or any software program being capable of generating random numbers to compute the transport values based on the derived transport probabilities. In this embodiment, a random number table is used and it is assumed that the transport value of the 1^{st} group is 1, the transport value of the 2^{nd} group is 0, the transport value of the 3^{rd} group is 1, and the transport value of the 4^{th} group is 0. Since these transport values are associated with the transport probabilities, the outcomes of the transport values in each implementation might be different. However, one can realize that the higher the transport probability is, the higher opportunity the transport value turns to be 1.

In step 805, because the transport probability of the 3^{rd} group is largest and its transport value is 1, the TFCs that cannot carry D5 and D6 are excluded. The transport probability of the 1^{st} group is second largest and its transport value is also 1 so that the method then excludes the TFCs that cannot carry D1 and D2. Since the transport values of the 2^{nd} and 4th groups are 0, they are not considered in this step.

In step 807, one available TFC is selected from the TFCs, that are not excluded yet, to process data transmission.

Load Measurement Based Priority Method

To take the data float of each logic channel into account, Load Measurement Based Priority Method assigns transport blocks to each transport channel in the current time frame by pre-estimating or pre-computing a possible input quantity of data in the next time frame in addition to priority attributes.

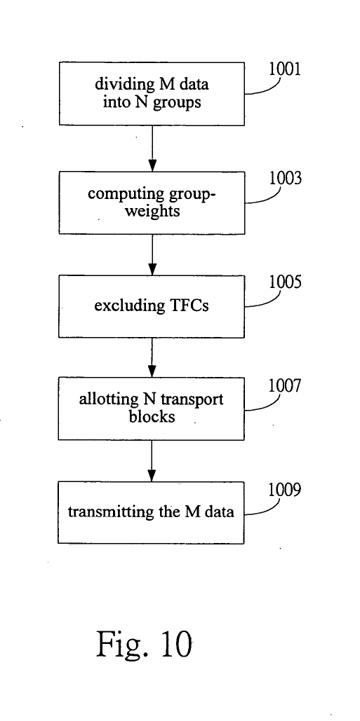

The steps of the method are illustrated in FIG. 10. In step 1001, M sets data are divided into N groups. Each group of data corresponds to one transport channel. In step 1003, a group-weight of each group is computed according to the priority attribute of each set of data and the quantity of data of each logical channel. Therefore, the N groups generate N group-weights. Each group-weight can be derived by using the following equation:

$${W}_{i} = \frac{1}{N} ( {\sum }_{j ∈ {S}_{i}}^{} \frac{1}{{P}_{j}} \times {BO}_{j} ) \qquad ( 2 )$$

wherein Wᵢ denotes the group-weight of the i^{th} group, Sᵢ denotes the ith group, Pⱼ denotes the priority attribute of the j^{th} set of data, and BOⱼ denotes the quantity of data of the j^{th} logical channel.

In step 1005, from one group having a largest group-weight to one group having a smallest group-weight or only one TFC available in the TFCS, exclude TFCs that are incapable of carrying all quantities of data in corresponding group.

In step 1007, the method allots the transport blocks to the N groups.

In step 1009, the M sets data are transmitted according to the results obtained in step 1007.

When there is more than one group having the same group-weight in step 1005, randomly select one of the groups having the same group-weight to exclude TFCs that are incapable of carrying all quantities of data in the corresponding group, or first exclude TFCs that are incapable of carrying all quantities of data in the corresponding group having the largest data quantity.

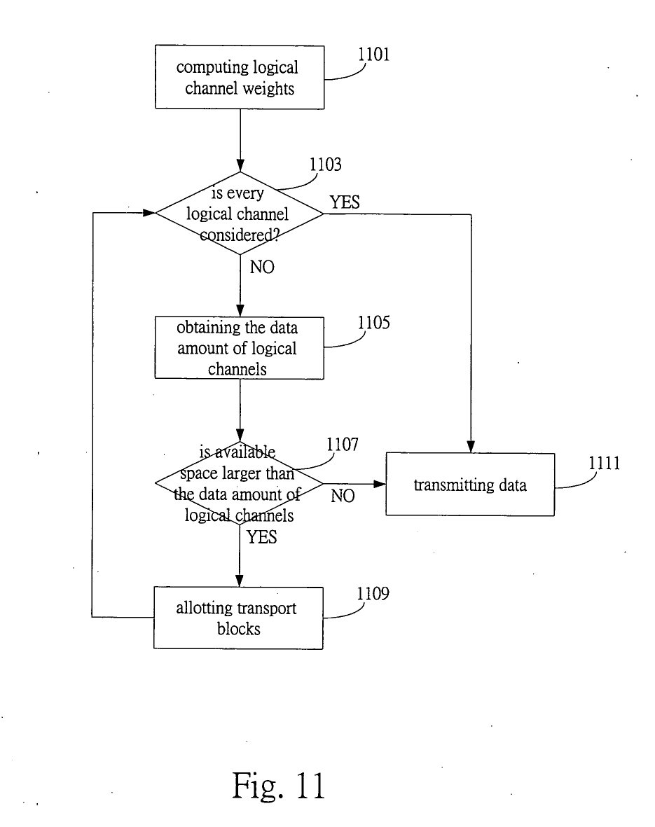

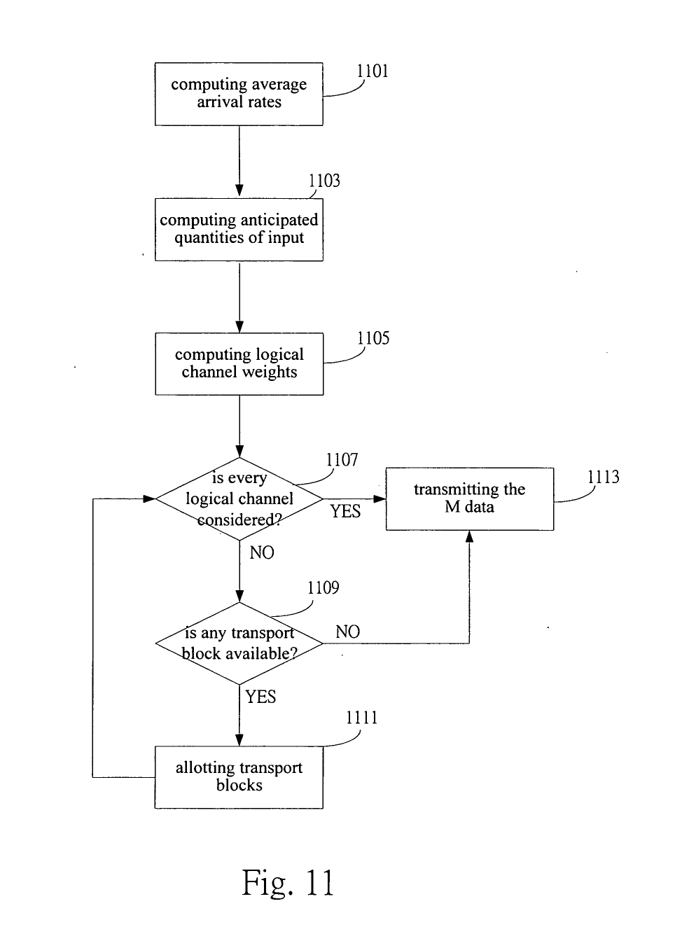

Step 1007 further includes the steps shown in FIG. 11. In step 1101, an average arrival rate a^{t}ⱼ of each logical channel is computed by the following equation:

$${a}_{j}^{t} = \frac{1}{T} \times {\sum }_{t1 = 0}^{T - 1} ( {BO}_{j}^{t - t1} - ( {BO}_{j}^{t - ( t1 + 1 )} - {BS}_{j}^{t - ( t1 + 1 )} ) ) \qquad ( 3 )$$

wherein T denotes the number of the time frame before the current time frame, BSⱼ^{t-(t1+1)} denotes the quantity of data being transmitted at the time t=t1+1. Equation 3 represents the average quantity of input of the corresponding logical channel counting from the beginning to the current time frame (unit: bits).

According to the above average arrival rate, an anticipated quantity of input of each logical channel for the next time frame is computed by:
BOⱼ^{t+1}=(BOⱼ^{t-1}−BSⱼ^{t-1})+a^{t}ⱼ (4)
The anticipated quantity of input for the next time frame is the unsent quantity of data (BOⱼ^{t-1}−BSⱼ^{t-1}) in the current time frame plus the average arrival rate of the logical channel derived from Equation 3. Based on the outcomes of Equation 4, the possible quantity of input of each logical channel for the next time frame can be pre-estimated and pre-computed.

In step 1105, a logical channel weight of each logical channel is computed according to the anticipated quantity derived in step 1103. The equation for the logical weight is:

$${w}_{L , j} = \frac{{BO}_{j}^{t + 1}}{{P}_{j}} \qquad ( 5 )$$

wherein w_{L,j} denotes the weight of the j^{th} logical channel. According to Equation 5, one can realize that a larger BOⱼ^{t+1} and a higher Pⱼ would derive a higher weight for allotting transport blocks.

Then the method starts to allot the transport blocks according to the logical channel weights. In step 1107, the method determines if all logic channels are considered. If not, the method goes to step 1109 to determine if any transport block is available. If all logic channels are considered in step 1107 or no transport block is available in step 1109, the method goes to step 1113, i.e. step 1009, to transmit data with the allotted transport blocks. The quantity of data unsent in the current time frame will be considered again in the next time frame.

Similar to the other methods of the present invention, when there is more than one logical channel having the same logical channel weight in step 1111, the method randomly allots the transport blocks to those having the same logical channel weight or first allots the transport blocks to a group with a largest data quantity among those having the same logical channel weight.

The above method can be understood more clearly by following an example. Assume that the example for a base station has six logical channels and two transport channels. In step 1001, six data are divided into two groups. The first group includes the data of A, B and C logical channels, and the second group includes the data of D, E and F channels. The TFCS of the example is shown in Table 1:

TABLE 1
(TFC for the first group, TFC for the second group)

| | | | |
|---|---|---|---|
| (8, 32) | (12, 20) | (18, 10) | (10, 12) |
| (18, 13) | (9, 20) | (16, 9) | (13, 17) |
| (8, 18) | (14, 14) | (10, 10) | (14, 8) |

Assuming that the current time frame is the fifth time frame counting from the beginning, the quantities of input, BO^{t}ⱼ (unit: bits), and the quantities of data having sent, BS^{t}ⱼ (unit: bits), of the first and second groups are shown in Tables 2 and 3 respectively:

TABLE 2

| first | A logical channel | | B logical channel | | C logical channel | |
|---|---|---|---|---|---|---|
| group | BO^{t}_{A} | BS^{t}_{A} | BO^{t}_{B} | BS^{t}_{B} | BO^{t}_{C} | BS^{t}_{C} |
| t = 0 | 60 | 56 | 33 | 24 | 30 | 24 |
| t = 1 | 80 | 80 | 24 | 24 | 41 | 32 |
| t = 2 | 52 | 48 | 11 | 8 | 25 | 16 |
| t = 3 | 70 | 42 | 30 | 16 | 35 | 40 |
| t = 4 | 74 | ? | 12 | ? | 44 | ? |

TABLE 3

| second | D logical channel | | E logical channel | | F logical channel | |
|---|---|---|---|---|---|---|
| group | BO^{t}_{D} | BS^{t}_{D} | BO^{t}_{E} | BS^{t}_{E} | BO^{t}_{F} | BS^{t}_{F} |
| t = 0 | 40 | 16 | 55 | 48 | 20 | 16 |
| t = 1 | 30 | 32 | 78 | 72 | 51 | 32 |
| t = 2 | 6 | 8 | 62 | 64 | 15 | 16 |
| t = 3 | 21 | 16 | 31 | 24 | 45 | 48 |
| t = 4 | 33 | ? | 65 | ? | 45 | ? |

The question marks in some entries of Tables 2 and 3 represent that the quantities of data BS^{t}ⱼ therein are unknown and are going to be derived by the following steps in the current time frame. The priority attributes and the required transport blocks of each logical channel in the first group are:

TABLE 4

| | A | | |
|---|---|---|---|
| | logical channel | B logical channel | C logical channel |
| priority attribute | 1 | 2 | 3 |
| transport block | 10 | 2 | 6 |

The priority attributes and the required transport blocks of each logical channel in the second group are:

TABLE 5

| | D | | |
|---|---|---|---|
| | logical channel | E logical channel | F logical channel |
| priority attribute | 2 | 3 | 1 |
| transport block | 5 | 9 | 6 |

wherein each transport block consists of 8 bits.

In step 1003, the group-weights of the first group and the second group are computed from Equation 2. They are:

$$\begin{matrix}{w}_{1} = \frac{1}{2} ( \frac{1}{1} \times 10 + \frac{1}{2} \times 2 + \frac{1}{3} \times 6 ) = 6.5 \\ {w}_{2} = \frac{1}{2} ( \frac{1}{2} \times 5 + \frac{1}{3} \times 9 + \frac{1}{1} \times 6 ) = 5.75\end{matrix}$$

Hence, the group-weight of the first group is 6.5 and the group-weight of the second group is 5.75. For simplification, the BO^{t}ⱼ values are substituted by the required transport blocks listed in Tables 4 and 5 instead of bits.

Since the group-weight of the first group is larger than that of the second group, the number (10+2+6=18) of the transport blocks of the first group is considered first in step 1005. Referring to Table 1, there are two TFCs satisfying the requirement of the first group, which are (18, 13) and (18, 10). Then the number (5+9+6=20) of the transport blocks of the second group is considered. Both of the two TFCs do not satisfy the requirement of the first group. The TFC (18, 13) which can carry a larger quantity of data is therefore selected.

Step 1007 is then executed to allot transport blocks and the further steps are shown in FIG. 11. In step 1101, the average arrival rates of the first group can be computed according to Equation 3 and Tables 2 and 3. They are:

$$\begin{matrix}{a}_{A}^{4} = \frac{1}{4} \times ( 74 - ( 70 - 42 ) + 70 - ( 52 - 48 ) + \\ 52 - ( 80 - 80 ) + 80 - ( 60 - 56 ) ) = 60\end{matrix}$$

$$\begin{matrix}{a}_{B}^{4} = \frac{1}{4} \times ( 12 - ( 30 - 16 ) + 30 - ( 11 - 8 ) + \\ 11 - ( 24 - 24 ) + 24 - ( 33 - 24 ) ) = 12.75\end{matrix}$$

$$\begin{matrix}{a}_{C}^{4} = \frac{1}{4} \times ( 44 - ( 35 - 40 ) + 35 - ( 25 - 16 ) + \\ 25 - ( 41 - 32 ) + 41 - ( 30 - 24 ) ) = 31.5\end{matrix}$$

The average arrival rates of the second group are:

$$\begin{matrix}{a}_{D}^{4} = \frac{1}{4} \times ( 33 - ( 21 - 16 ) + 21 - ( 6 - 8 ) + \\ 6 - ( 30 - 32 ) + 30 - ( 40 - 16 ) ) = 16.25\end{matrix}$$

$$\begin{matrix}{a}_{E}^{4} = ( 78 - 72 ) + 78 - ( 55 - 48 ) ) = 54.5 \\ \frac{1}{4} \times ( 65 - ( 31 - 24 ) + 31 - ( 62 - 64 ) + 62 -\end{matrix}$$

$$\begin{matrix}{a}_{F}^{4} = \frac{1}{4} \times ( 45 - ( 45 - 48 ) + 45 - ( 15 - 16 ) + 15 - \\ ( 51 - 32 ) + 51 - ( 20 - 16 ) ) = 34.25\end{matrix}$$

In step 1103, the anticipated quantities of input of the first group can be computed according to Equation 4. They are:
BO_{A}^{t+1}=(70−42)+60=88
BO_{B}^{t+1}=(30−16)+12.75=26.75
BO_{C}^{t+1}=(35−40)+31.5=26.5
The anticipated quantities of input of the second group are:
BO_{D}^{t+1}=(21−16)+16.25=21.25
BO_{E}^{t+1}=(31−24)+54.5=61.5
BO_{F}^{t+1}=(45−48)+34.25=31.25

In step 1105, each logical channel weight is computed. According to Equation 5, the logical channel weights of the first group are:

$$\begin{matrix}{W}_{L , A} = \frac{88}{1} = 88 \\ {W}_{L , B} = \frac{26.75}{2} = 13.375 \\ {W}_{L , C} = \frac{26.5}{3} = 8.83\end{matrix}$$

The logical weights of the second group are:

$$\begin{matrix}{W}_{L , D} = \frac{21.5}{2} = 10.75 \\ {W}_{L , E} = \frac{61.5}{3} = 20.5 \\ {W}_{L , F} = \frac{31.25}{1} = 31.25\end{matrix}$$

Because there is no transport blocks being allotted yet in steps 1107 and 1109, step 1111 is executed to assign transport blocks to the logical channel having the highest logical channel weight for each group, i.e. logical channel A for the first group and logical channel F for the second channel. The number of the transport blocks assigned to logical channel A is:

$$\frac{88}{88 + 13.375 + 8.83} \times 18 ≅ 14$$

These 14 transport blocks are sufficient to transmit the 74 bits at t=4 and the remaining data at t=0˜3. There are four transport blocks available after all data of logical channel A are considered.

The number of the transport blocks assigned to logical channel F is:

$$\frac{31.25}{10.75 + 20.5 + 31.25} \times 13 ≅ 7$$

Seven transport blocks can carry most data of F logical channel at t=0˜4 and 8 bits are unsent. There are six transport blocks available after logical channel F is considered.

According to the steps shown in FIG. 11, the method returns to step 1107. There are B, C, D and E logical channels that are not considered yet and also some transport blocks are available. Step 1111 is executed again to assign transport blocks to the logical channel having the second highest logical channel weight in each group, i.e. logical channel B for the first group and logical channel E for the second channel. The number of the transport blocks assigned to logical channel B is:

$$\frac{13.375}{13.375 + 8.83} \times 4 ≅ 2$$

Two transport blocks can carry some data of logical channel B at t=0˜4 and 22 bits are unsent. There are two transport blocks available after logical channels A and B are considered.

The number of the transport blocks assigned to logical channel E is:

$$\frac{20.5}{10.75 + 20.5} \times 6 ≅ 4$$

Four transport blocks can carry some data of logical channel E and 51 bits are unsent. There are two transport blocks available after logical channels F and E are considered.

The method returns to step 1107. There are logical channels C and D that are not considered yet and also some transport blocks are available. Step 1111 is executed again to assign transport blocks to logical channels C and D. Logical channels C and D obtain two transport blocks respectively so there are 47 bits of logical channel C unsent and 42 bits of logical channels D unsent in the current time frame.

The method returns to step 1107 again. All logical channels are assigned and, therefore, step 1113, i.e. step 1009, is executed to transmit data based on the arrangement in step 1111.

The above description of the preferred embodiments is expected to clearly expound the characteristics of the present invention but not expected to restrict the scope of the present invention. Those skilled in the art will readily observe that numerous modifications and alterations of the method may be made while retaining the teaching of the invention. Accordingly, the above disclosure should be construed as limited only by the bounds of the claims.

1. A method for a base station in a radio access network to process data transmission, the base station comprising a media access control layer for receiving M sets data from M logical channels and outputting the M sets data via N transport channels after processing, M being larger than N, each set of data having a priority attribute, the media access control layer comprising a set of transport format combinations, the set comprising a plurality of transport format combinations accessible to the N transport channels, the method comprising the steps of
(a) dividing the M sets data into N groups, each group of data corresponding to one transport channel;
(b) for each group, determining which set of data has a highest priority attribute and defining the set of data having the highest priority attribute as a main set of data of a corresponding group;
(c) from one group having a corresponding main set of data with a highest priority attribute to one group having a corresponding main set of data with a lowest priority attribute, excluding transport format combinations that are incapable of carrying the corresponding main set of data; and
(d) selecting one of available transport format combinations from the set to process data transmission.

2. The method of claim 1, wherein, in step (b), when there is more than one set of data having the highest priority attribute in the corresponding group, at random define one set of data having the highest priority attribute in the corresponding group as the main set of data.

3. The method of claim 1, wherein, in step (b), when there is more than one set of data having the highest priority attribute in the corresponding group, define one set of data having the highest priority attribute as well as having a most quantity of data in the corresponding group as the main set of data.

4. The method of claim 1, wherein, in the step (c), if only one transport format combination available in the set before the group having the corresponding main set of data with the lowest priority attribute is considered, the available transport format combination is selected in the step (d).

5. A method for a base station in a radio access network to process data transmission, the base station comprising a media access control layer for receiving M sets data from M logical channels and outputting the M sets data via N transport channels after processing, M being larger than N, each set of data having a priority attribute, the media access control layer comprising a set of transport format combinations, the set comprising a plurality of transport format combinations accessible to the N transport channels, the method comprising the steps of:
(a) dividing the M sets data into N groups, each group of data corresponding to one transport channel;
(b) for each group, determining which set of data has a highest priority attribute and defining the set of data having the highest priority attribute as a main set of data of the corresponding group;
(c) from one group having a corresponding main set of data with a highest priority attribute to only one transport format combination available in the set, excluding transport format combinations that are incapable of carrying the corresponding main set of data; and
(d) selecting the available transport format combination from the set to process data transmission.

6. The method of claim 5, wherein, in step (b), when there is more than one set of data having the highest priority attribute in the corresponding group, at random define one set of data having the highest priority attribute in the corresponding group as the main set of data.

7. The method of claim 5, wherein, in step (b), when there is more than one set of data having the highest priority attribute in the corresponding group, define one set of data having the highest priority attribute as well as having a most quantity of data in the corresponding group as the main set of data.

8. The method of claim 5, wherein, in the step (c), if all groups are considered and there is more than one transport format combination available in the set, an available transport format combination that is capable of carrying a most quantity of data is selected in the step (d).

9. A method for a base station in a radio access network to process data transmission, the base station comprising a media access control layer for receiving M sets data from M logical channels and outputting the M sets data via N transport channels after processing, M being larger than N, each set of data having a priority attribute, the media access control layer comprising a set of transport format combinations, the set comprising a plurality of transport format combinations accessible to the N transport channels, the method comprising the steps of
(a) dividing the M sets data into N groups, each group of data corresponding to one transport channel;
(b) for each group, determining which set of data has a highest priority attribute and defining the set of data having the highest priority attribute as a main set of data of the corresponding group;
(c) from one group having a corresponding main set of data with a highest priority attribute to one group having a corresponding main set of data with a lowest priority attribute or only one transport format combination available in the set, excluding transport format combinations that are incapable of carrying the corresponding main set of data; and
(d) selecting one of available transport format combinations from the set to process data transmission.

10. A method for a base station in a radio access network to process data transmission, the base station comprising a media access control layer for receiving M sets data from M logical channels and outputting the M sets data via N transport channels after processing, M being larger than N, each set of data having a priority attribute, each logical channel comprising a buffer for temporarily storing a set of data, the method comprising the steps of
(a) setting a buffer threshold;
(b) dividing the M sets data into N groups, each group of data corresponding to one transport channel;
(c) determining if a quantity of the set of data is larger than the buffer threshold, if yes, marking the set of data as H, if not, marking the set of data as L;
(d) for each group, appropriately replacing priority attributes according to the H and L marks of the data in each group; and
(e) transmitting the M sets data based on the priority attributes after replacement.

11. The method of claim 10, wherein the step (d) further comprises the steps of.
(f) for each group, comparing the numbers of the data marked as H and L, and obtaining a smaller number as R;
(g) for each group, rearranging priority attributes of R data marked as L so that each of the R data marked as L with a larger quantity has a higher priority attribute, wherein the R data marked as L are R data marked as L with smaller quantities in each group;
(h) for each group, rearranging priority attributes of R data marked as H so that each of the R data marked as H with a larger quantity has a higher priority attribute, wherein the R data marked as H are R data marked as H with larger quantities in each group; and
(i) exchanging priority attributes of a set of data marked as L with a highest priority attribute in the R data marked as L and a set of data marked as H with a highest priority attribute in the R data marked as H, exchanging priority attributes of a set of data marked as L with a second highest priority attribute in the R data marked as L and a set of data marked as H with a second highest priority attribute in the R data marked as H, and so on.

12. The method of claim 10, wherein the step (d) further comprises the steps of:
(j) for each group, rearranging priority attributes of all data marked as L so that a set of data marked as L with a larger quantity has a higher priority attribute;
(k) for each group, rearranging priority attributes of all data marked as H so that a set of data marked as H with a larger quantity has a higher priority attribute; and
(l) for each group, exchanging priority attributes of a set of data marked as L with a highest priority attribute and a set of data marked as H with a highest priority attribute, exchanging priority attributes of a set of data marked as L with a second highest priority attribute and a set of data marked as H with a second highest priority attribute, and so on.

13. A method for a base station in a radio access network to process data transmission, the base station comprising a media access control layer for receiving M sets data from M logical channels and outputting the M sets data via N transport channels after processing, M being larger than N, each set of data having a priority attribute, the M sets data being divided into N groups and each group of data corresponding to one N transport channel, the media access control layer comprising a set of transport format combinations, the set comprising a plurality of transport format combinations accessible to the N transport channels, the method comprising the steps of
(a) computing a transport probability of each group;
(b) computing a transport value of each group, wherein a probability of the transport value as being 1 is the transport probability of the each group, a probability of the transport value as being 0 is (1 minus the transport probability of the each group);
(c) from one group having a largest transport probability to one group having a smallest transport probability, excluding transport format combinations that are incapable of carrying all data in the group if the transport value of the group is equal to 1; and
(d) selecting one of available transport format combinations from the set to process data transmission.

14. The method of claim 13, wherein, in the step (a), the transport probability is computed according to a priority attribute of each set of data in each group and priority attributes of the M sets data.

15. The method of claim 13, wherein the step (c) further comprises the step of ignoring the group if the transport value of the group is equal to 0.

16. The method of claim 13, wherein, in the step (c), when there is more than one group having a same transport probability, at random exclude transport format combinations that are incapable of carrying all data in one group.

17. The method of claim 13, wherein, in the step (c), when there is more than one group having a same transport probability, first exclude transport format combinations that are incapable of carrying all data in one group having a largest quantity.

18. The method of claim 13, wherein, in the step (c), if only one transport format combination available in the set before the group having a smallest transport probability is considered, the available transport format combination is selected in the step (d).

19. The method of claim 13, wherein, in the step (d), if there is more than one transport format combination available in the set, an available transport format combination that is capable of carrying a most quantity of data is selected.

20. A method for a base station in a radio access network to process data transmission, the base station comprising a media access control layer for receiving M sets data from M logical channels and outputting the M sets data via N transport channels after processing, M being larger than N, each set of data having a priority attribute, the M sets data being divided into N groups and each group of data corresponding to one transport channel, the media access control layer comprising a set of transport format combinations, the set comprising a plurality of transport format combinations accessible to the N transport channels, the method comprising the steps of
(a) computing a transport probability of each group;
(b) computing a transport value of each group, wherein a probability of the transport value as being 1 is the transport probability of the each group, a probability of the transport value as being 0 is (1 minus the transport probability of the each group);
(c) from one group having a largest transport probability to only one transport format combination available in the set, excluding transport format combinations that are incapable of carrying all data in the group if the transport value of the group is equal to 1; and
(d) selecting one of available transport format combinations from the set to process data transmission.

21. The method of claim 20, wherein, in the step (a), the transport probability is computed according to a priority attribute of each set of data in each group and priority attributes of the M sets data.

22. The method of claim 20, wherein the step (c) further comprises the step of ignoring the group if the transport value of the group is equal to 0.

23. The method of claim 20, wherein, in the step (c), when there is more than one group having a same transport probability, at random exclude transport format combinations that are incapable of carrying all data in a group.

24. The method of claim 20, wherein, in the step (c), when there is more than one group having a same transport probability, first exclude transport format combinations that are incapable of carrying all data in a group with a largest quantity.

25. The method of claim 20, wherein, in the step (c), if all groups are considered and there is more than one transport format combination available in the set, an available transport format combination that is capable of carrying a most quantity of data is selected in the step (d).

26. A method for a base station in a radio access network to process data transmission, the base station comprising a media access control layer for receiving M sets data from M logical channels and outputting the M sets data via N transport channels after processing, M being larger than N, the M sets data being divided into N groups and each group of data corresponding to one transport channel, the media access control layer comprising a set of transport format combinations, the set comprising a plurality of transport format combinations accessible to the N transport channels, the method comprising the steps of:
(a) computing a transport probability of each group;
(b) computing a transport value of each group, wherein a probability of the transport value as being 1 is the transport probability of the each group, a probability of the transport value as being 0 is (1 minus the transport probability of the each group);
(c) from one group having a largest transport probability to one group having a smallest transport probability or only one transport format combination available in the set, excluding transport format combinations that are incapable of carrying all data in the group if the transport value of the group is equal to 1; and
(d) selecting one of available transport format combinations from the set to process data transmission.

27. A method for a base station in a radio access network to process data transmission, the base station comprising a media access control layer for receiving M sets data from M logical channels and outputting the M sets data via N transport channels after processing, M being larger than N, each set of data having a priority attribute, each logical channel comprising a buffer for temporarily storing a quantity of data, the media access control layer comprising a set of transport format combinations, the set comprising a plurality of transport format combinations accessible to the N transport channels, each transport format combination comprising a plurality of transport blocks, the method comprising the steps of
(a) dividing the M sets data into N groups, each group of data corresponding to one transport channel;
(b) for each group, computing a group-weight by using priority attributes of all data and the quantity of data, and forming N group-weights;
(c) from one group having a largest group-weight to one group having a smallest group-weight or only one transport format combination available in the set, excluding transport format combinations that are incapable of carrying all quantities of data in corresponding group;
(d) allotting the plurality of transport blocks to the N groups; and
(e) transmitting the M sets data.

28. The method of claim 27, wherein, in the step (c), when there is more than one group having a same group-weight, at random exclude transport format combinations that are incapable of carrying all quantities of data in a corresponding group.

29. The method of claim 27, wherein, in the step (c), when there is more than one group having a same group-weight, first exclude transport format combinations that are incapable of carrying all quantities of data in a corresponding group having a largest data quantity.

30. The method of claim 27, wherein the step (d) further comprising the steps of:
(f) computing an average arrival rate of each logical channel;
(g) computing an anticipated quantity of input of each logical channel;
(h) computing a logical channel weight of each logical channel; and
(i) allotting the plurality of transport blocks according to the logical channel weight.

31. The method of claim 30, wherein, in the step (i), when there is more than one logical channel having a same logical channel weight, at random allot the plurality of transport blocks.

32. The method of claim 30, wherein, in the step (i), when there is more than one logical channel having a same logical channel weight, first allot the plurality of transport blocks to a group with a largest data quantity.

33. A method for a base station in a radio access network to process data transmission, the base station comprising a media access control layer for receiving M sets data from M logical channels and outputting the M sets data via N transport channels after processing, M being larger than N, each set of data having a priority attribute, each logical channel comprising a buffer for temporarily storing a quantity of data, the media access control layer comprising a set of transport format combinations, the set comprising a plurality of transport format combinations accessible to the N transport channels, each transport format combination comprising a plurality of transport blocks, the method comprising the steps of:
(a) dividing the M sets data into N groups, each group of data corresponding to one transport channel;
(b) for each group, computing a group-weight by using priority attributes of all data in the group and the quantity of data, and forming N group-weights;
(c) from one group having a largest group-weight to one group having a smallest group-weight or only one transport format combination available in the set, excluding transport format combinations that are incapable of carrying all quantities of data in a corresponding group;
(d) computing an average arrival rate of each logical channel;
(e) computing an anticipated quantity of input of each logical channel;
(f) computing a logical channel weight of each logical channel;
(g) allotting the plurality of transport blocks according to the logical channel weight; and
(h) transmitting the M sets data.

34. The method of claim 33, wherein, in the step (c), when there is more than one group having a same group-weight, at random exclude transport format combinations that are incapable of carrying all quantities of data in a corresponding group.

35. The method of claim 33, wherein, in the step (c), when there is more than one group having a same group-weight, first exclude transport format combinations that are incapable of carrying all quantities of data in a corresponding group having a largest quantity of data.

36. The method of claim 33, wherein, in the step (g), when there is more than one logical channel having a same logical channel weight, at random allot the plurality of transport blocks.

37. The method of claim 33, wherein, in the step (g), when there is more than one logical channel having a same logical channel weight, first allot the plurality of transport blocks to a group having a largest quantity of data.
